(19) United States
(12) Patent Application Publication
(10) Pub. No.: US 2024/0174549 A1
(43) Pub. Date: May 30, 2024

(54) STRENGTHENED GLASSES WITH SODA LIME SILICATE GLASS CULLET ACCEPTABILITY

(71) Applicant: CORNING INCORPORATED, CORNING, NY (US)

(72) Inventor: Peter Joseph Lezzi, Corning, NY (US)

(21) Appl. No.: 18/386,278

(22) Filed: Nov. 2, 2023

Related U.S. Application Data
(60) Provisional application No. 63/428,570, filed on Nov. 29, 2022.

(51) Int. Cl. C03C 3/087; C03C 21/00

(52) U.S. Cl. CPC C03C 3/087; C03C 21/002

(57) ABSTRACT

An alkali aluminosilicate glass article has a glass composition of 68.5 mol % to 76.5 mol % SiO₂, 5.5 mol % to 11.0 mol % Al₂O₃, 9.0 mol % to 14.5 mol % Na₂O, 4.0 mol % to 5.7 mol % MgO, 1.0 mol % to 4.8 mol % CaO, and 0.05 mol % to 3.9 mol % K₂O. The glass article may be ion exchanged to have one or more compressed surface layers. The glass article may be made from raw materials containing soda-lime glass cullet.

This application claims the benefit of priority under 35 U.S.C. § 119 of U.S. Provisional Application Ser. No. 63/428,570 filed on Nov. 29, 2022, the content of which is relied upon and incorporated herein by reference in its entirety.

### BACKGROUND

### Field

The present specification generally relates to alkali aluminosilicate glasses. More specifically, the present specification is directed to alkali aluminosilicate glasses that are made from raw materials containing commercial soda-lime silicate glasses (SLG) cullet and can be ion-exchanged to achieve high peak compressive stresses (CS) and a thick depth of layer (DOL).

### Technical Background

Soda-lime-silicate glass (SLG) is one of the most widely used glasses for recycling. SLG is the most prevalent type of glass being used for window panes and glass containers like bottles and jars for drink, food, and other commodity items. Recycling glasses can make manufacturing new glass products more sustainable and eco-friendly. For instance, it helps reduce pollution and waste; it saves energy used in manufacturing because cullet often melts at a lower temperature; it reduces air pollution and related water pollution that results from producing similar glasses; and it reduces the space in landfills by reducing disposed of cullet. One thing that makes SLG suitable for recycling is that SLG can be resoftened and remelted numerous times.

### SUMMARY

The present disclosure is directed to glass compositions having suitable strength and flexibilities for various applications.

In embodiments, an alkali aluminosilicate glass article comprises: from greater than or equal to 68.5 mol % to less than or equal to 76.5 mol % SiO₂; from greater than or equal to 5.5 mol % to less than or equal to 11.0 mol % Al₂O₃; from greater than or equal to 9.0 mol % to less than or equal to 14.5 mol % Na₂O; from greater than or equal to 4.0 mol % to less than or equal to 5.7 mol % MgO; from greater than or equal to 1.0 mol % to less than or equal to 4.8 mol % CaO; from greater than or equal to 0.05 mol % to less than or equal to 3.9 mol % K₂O; and wherein CaO mol %−K₂O mol % is greater than or equal to −1.5 mol % and less than or equal to 4.8 mol %.

In one or more embodiments, an ion-exchange strengthened alkali aluminosilicate glass article comprising: from greater than or equal to 68.5 mol % to less than or equal to 76.5 mol % SiO₂; from greater than or equal to 5.5 mol % to less than or equal to 11.0 mol % Al₂O₃; from greater than or equal to 9.0 mol % to less than or equal to 14.5 mol % Na₂O; from greater than or equal to 4.0 mol % to less than or equal to 5.7 mol % MgO; from greater than or equal to 1.0 mol % to less than or equal to 4.8 mol % CaO; from greater than or equal to 0.05 mol % to less than or equal to 3.9 mol % K₂O; wherein CaO mol %−K₂O mol % is greater than or equal to −1.5 mol % and less than or equal to 4.8 mol %; andvwherein the ion-exchange strengthened glass article has one or more compressed surface layers.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of a glass having compressive stress layers on surfaces thereof according to embodiments disclosed and described herein;

FIG. 2 schematically depicts an exemplary electronic device incorporating a glass article according to any of the glass articles disclosed and described herein.

FIG. 3 is a plot graph of depth of layer (DOL) versus CaO—K₂O mol % according to embodiments disclosed and described herein;

FIG. 4 is a plot graph of depth of layer (DOL) versus (Na₂O+K₂O—CaO) mol % according to embodiments disclosed and described herein;

FIG. 5 is a plot graph of DOL versus CS for various exemplary glass compositions comparing with calcium free glasses according to embodiments disclosed and described herein;

FIG. 6 is a plot graph of DOL versus CS for various exemplary glass compositions and non-alkali aluminosilicate glasses, such as PPG SLG, Guardian SLG, according to embodiments disclosed and described herein; and

FIG. 7 is a plot graph of DOL versus CS for various exemplary glass compositions, elective non-calcium alkali aluminosilicate glasses, and non-alkali aluminosilicate glasses, such as PPG SLG, Guardian SLG under different ion-exchange treatment time and treatment temperature.

### DETAILED DESCRIPTION

Although SLG cullet is good for recycling, SLG cullet is generally not suitable for glass compositions that are to be chemically strengthened, such as by ion exchange strengthening. This is because commercial SLG contains a comparably high calcium content of around 9 weight percent (wt %), which is adverse to strengthening glasses through an ion exchange treatment. However, glass compositions disclosed and described herein are eco-friendly alkali aluminosilicate glasses that can be formed using SLG cullet and that do not sacrifice performance.

The commercial alkali aluminosilicate glasses are usually not made from SLG raw material. SLG typically contains a calcium percentage of around 8 to 9 wt %. Such high calcium content is unfavorable for glass compositions that are intended to be strengthened by ion exchange processes because calcium introduces negative effects to the glass ionic diffusivity. Particularly, the magnitude of surface compression as well as the depth of compressive stress layer (DOL) play an important role in creating stronger glasses. The negative effects of the lower diffusivity from increased calcium in SLG cullet introduces challenges to reach a favorable DOL. One solution to negate this lower DOL is by increasing the potassium content in the alkali aluminosilicate glasses. The magnitude of surface compression is typically measured as peak compressive stresses (CS). However, increasing the potassium content too much will reduce the CS. The alkali aluminosilicate glass compositions described herein, despite comparable high calcium mole percentage, can be ion-exchanged to achieve properties, such as CS and DOL, that are at least comparable with alkali aluminosilicate glasses that are not made with SLG cullet and, thus, do not have as high of a calcium content.

Reference will now be made in detail to alkali aluminosilicate glasses according to various embodiments. The physical properties of alkali aluminosilicate glasses generally may be related to the glass composition and structure.

In addition, alkali aluminosilicate glasses have good ion exchange ability, and chemical strengthening processes have been used to achieve high strength and high toughness properties in alkali aluminosilicate glasses. Sodium aluminosilicate glasses are highly ion exchangeable glasses with high glass formability and quality. The substitution of Al₂O₃ into the silicate glass network increases the interdiffusivity of monovalent cations during ion exchange. The diffusivity, as measured in diffusion coefficients, is one of the key factors in determining the ion-exchange ability in alkali aluminosilicate glasses, which depends on the glass framework and ion sizes. By chemical strengthening in a molten salt bath (e.g., KNO₃), glasses with high strength and high toughness can be achieved.

The SLG glass cullet that may be recycled and used in alkali aluminosilicate glasses according to embodiments is crushed or imploded waste glasses and is readily remelted, and includes both internal SLG cullet and external SLG cullet. The raw materials herein in fabricating the alkali aluminosilicate glasses may include a significant amount of SLG cullet and/or other glasses or compositions containing considerable high calcium content.

Described herein are alkali aluminosilicate glass compositions that may be ion-exchanged to achieve high peak compressive stress (CS) at a decent depth of layer (DOL), according to embodiments, physical properties of alkali aluminosilicate glass compositions according to embodiments, and ion exchange ability benefits of alkali aluminosilicate glass compositions according to embodiments before and after ion exchange.

In embodiments of glass compositions described herein, the concentration of constituent components (e.g., SiO₂, Al₂O₃, and the like) are given in mole percent (mol %) on an oxide basis, unless otherwise specified. Components of the alkali aluminosilicate glass composition according to embodiments are discussed individually below. It should be understood that any of the variously recited ranges of one component may be combined with the any of the variously recited ranges for any other component.

In an exemplary alkali aluminosilicate glass composition, SiO₂ is the largest constituent and, as such, SiO₂ is the primary constituent of the glass network formed from the glass composition. Pure SiO₂ has a relatively low coefficient of thermal expansion (CTE) and is alkali free. However, pure SiO₂ has an extremely high melting point. Accordingly, if the concentration of SiO₂ in the glass composition is too high, the formability of the glass composition may be diminished as higher concentrations of SiO₂ increase the difficulty of melting the glass, which, in turn, adversely impacts the formability of the glass. In embodiments, the glass composition generally comprises SiO₂ in an amount from greater than or equal to 68.5% to less than or equal to 76.5 mol %. In embodiments, the glass composition comprises SiO₂ in amounts greater than or equal to 70.0 mol %, greater than or equal to 72.5 mol %, or greater than or equal to 75.0 mol %. In embodiments, the glass composition comprises SiO₂ in amounts less than or equal to 75.0 mol %, less than or equal to 72.5 mol %, or less than or equal to 70.0 mol %. In embodiments, the glass composition comprises SiO₂ in an amount from greater than or equal to 69.0 mol % to less than or equal to 71.0 mol %, such as from greater than or equal to 73.0 mol % to less than or equal to 75.0 mol %. In embodiments, the glass composition comprises SiO₂ in an amount from greater than or equal to 69.0 mol % to less than or equal to 69.5 mol %.

The glass composition of embodiments may further comprise Al₂O₃. Al₂O₃ may serve as a glass network former, similar to SiO₂. Al₂O₃ may increase the viscosity of the glass composition due to its tetrahedral coordination in a glass melt formed from a properly designed glass composition, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes, such as the fusion forming process. In embodiments, the glass composition generally comprises Al₂O₃ in a concentration of from greater than or equal to 5.5 mol % to less than or equal to 11.0 mol %. In embodiments, the glass composition comprises Al₂O₃ in amounts greater than or equal to 6.0 mol %, greater than or to 7.0 mol %, greater than or equal to 8.0 mol %, greater than or equal to 9.0 mol %, or greater than or equal to 10.0 mol %. In embodiments, the glass composition comprises Al₂O₃ in amounts less than or equal to 10.0 mol %, less than or equal to 9.0 mol %, less than or equal to 8.0 mol %, less than or equal to 7.0 mol %, or less than or equal to 6.0 mol %. In embodiments, the glass composition comprises Al₂O₃ in an amount from greater than or equal to 6.0 mol % to less than or equal to 10.0 mol %, such as from greater than or equal to 6.5 mol % to less than or equal to 9.5 mol %, from greater than or equal to 7.0 mol % to less than or equal to 9.0 mol %, or from greater than or equal to 7.5 mol % to less than or equal to 8.5 mol %. In embodiments, the glass composition comprises Al₂O₃ in an amount from greater than or equal to 10.0 mol % to less than or equal to 11.0 mol %.

According to embodiments, the glass composition may also comprise alkali metal oxides, such as Na₂O and K₂O, for example. The combination of these alkali metal oxides (e.g. Na₂O+K₂O) may also be referred to as R₂O. Na₂O aids in the ion exchange ability of the glass composition, and also increases the melting point of the glass composition and improves formability of the glass composition. However, if too much Na₂O is added to the glass composition, the CTE may be too low, and the melting point may be too high. In embodiments, the glass composition generally comprises Na₂O in an amount from greater than or equal to 9.0 mol % to less than or equal to 14.5 mol %. In embodiments, the glass composition comprises Na₂O in amounts greater than or equal to 9.0 mol %, greater than or equal to 10.0 mol %, greater than or to 11.0 mol %, greater than or equal to 12.0 mol %, greater than or equal to 13.0 mol %, or greater than or equal to 14.0 mol %. In embodiments, the glass composition comprises Na₂O in amounts less than or equal to 10.0 mol %, less than or equal to 11.0 mol %, less than or to 12.0 mol %, less than or equal to 13.0 mol %, less than or equal to 14.0 mol %, less than or equal to 14.5 mol %. In embodiments, the glass composition comprises Na₂O in an amount from greater than or equal to 9.5 mol % to less than or equal to 14.0 mol %, such as from greater than or equal to 10.0 mol % to less than or equal to 13.5 mol %, from greater than or equal to 10.5 mol % to less than or equal to 13.0 mol %, from greater than or equal to 11.0 mol % to less than or equal to 13.5 mol %, from greater than or equal to 11.5 mol % to less than or equal to 13.0 mol %, or from greater than or equal to 12.0 mol % to less than or equal to 12.5 mol %. In embodiments, the glass composition comprises Na₂O in an amount from greater than or equal to 12.5 mol % to less than or equal to 13.0 mol %.

Like Na₂O, K₂O also promotes ion exchange and increases the DOL of a compressive stress layer. However, K₂O may reduce the peak compressive stress, the CTE may be too low, and the melting point may be too high. In embodiments, the glass composition generally comprises K₂O in a concentration of from greater than or equal to 0.05 mol % to less than or equal to 3.90 mol %. In embodiments, the glass composition comprises K₂O in amounts greater than or equal to 0.10 mol %, greater than or equal to 0.25 mol %, greater than or equal to 0.50 mol %, greater than or to 1.00 mol %, greater than or equal to 2.00 mol %, greater than or to 2.50 mol %, greater than or equal to 3.00 mol %, or greater than or equal to 3.50 mol %. In embodiments, the glass composition comprises K₂O in amounts less than or equal to 0.25 mol %, less than or equal to 0.50 mol %, less than or equal to 1.00 mol %, less than or equal to 1.50 mol %, less than or equal to 2.00 mol %, less than or equal to 2.50 mol %, less than or equal to 3.00 mol %, or less than or equal to 3.50 mol %. In embodiments, the glass composition comprises K₂O in an amount from greater than or equal to 0.25 mol % to less than or equal to 3.50 mol %, such as from greater than or equal to 0.50 mol % to less than or equal to 3.00 mol %, from greater than or equal to 1.00 mol % to less than or equal to 2.50 mol %, or from greater than or equal to 1.50 mol % to less than or equal to 2.00 mol %. In embodiments, the glass composition comprises K₂O in an amount from greater than or equal to 0.25 mol % to less than or equal to 0.35 mol %.

MgO lowers the viscosity of a glass, which enhances the formability, the strain point, and the Young's modulus. However, when too much MgO is added to the glass composition, the density and the CTE of the glass composition increase and the diffusivity of ions within the glass decreases. In embodiments, the glass composition generally comprises MgO in a concentration of from greater than or equal to 4.0 mol % to less than or equal to 5.7 mol %. In embodiments, the glass composition comprises MgO in amounts greater than or equal to 4.0 mol %, greater than or equal to 4.5 mol %, greater than or to 5.0 mol %, or greater than or equal to 5.5 mol %. In embodiments, the glass composition comprises MgO in amounts less than or equal to 4.5 mol %, less than or equal to 5.0 mol %, or less than or equal to 5.5 mol %. In embodiments, the glass composition comprises MgO in an amount from greater than or equal to 4.0 mol % to less than or equal to 5.5 mol %, such as from greater than or equal to 4.3 mol % to less than or equal to 5.3 mol %, or from greater than or equal to 4.5 mol % to less than or equal to 5.0 mol %. In embodiments, the glass composition comprises MgO in an amount from greater than or equal to 4.8 mol % to less than or equal to 5.2 mol %.

CaO lowers the viscosity of a glass, which enhances the formability, the strain point, and the Young's modulus. However, when too much CaO is added to the glass composition, the density and the CTE of the glass composition increase and the diffusivity of ions within the glass decreases. In embodiments, the glass composition generally comprises CaO in a concentration of from greater than or equal to 1.0 mol % to less than or equal to 4.8 mol %. In embodiments, the glass composition comprises CaO in amounts greater than or equal to 1.5 mol %, greater than or equal to 2.0 mol %, greater than or to 2.5 mol %, greater than or equal to 3.0 mol %, greater than or to 3.5 mol %, greater than or equal to 4.0 mol %, or greater than or equal to 4.5 mol %. In embodiments, the glass composition comprises CaO in amounts less than or equal to 1.5 mol %, less than or equal to 2.0 mol %, less than or equal to 2.5 mol %, less than or equal to 3.0 mol %, less than or equal to 3.5 mol %, less than or equal to 4.0 mol %, or less than or equal to 4.5 mol %. In embodiments, the glass composition comprises CaO in an amount from greater than or equal to 1.5 mol % to less than or equal to 4.5 mol %, such as from greater than or equal to 2.0 mol % to less than or equal to 4.0 mol %, or from greater than or equal to 2.5 mol % to less than or equal to 3.5 mol %. %. In embodiments, the glass composition comprises CaO in an amount from greater than or equal to 2.2 mol % to less than or equal to 2.3 mol %.

In embodiments, the glass composition may optionally include one or more fining agents. In embodiments, the fining agents may include, for example, SnO₂. In such embodiments, SnO₂ may be present in the glass composition in an amount less than or equal to 0.2 mol %.

In any embodiment described above, the glass composition may be substantially free of B₂O₃, P₂O₅, Li₂O, or combinations thereof. It should be understood that in embodiments the glass composition may be substantially free of all three of these components, the glass composition may be substantially free of any two of these components, and in embodiments, the glass composition may be substantially free of any one of these components. As used herein, the term “substantially free” means that the component is not added as a component of the batch material even though the component may be present in the final glass in very small amounts as a contaminate, such as less than 0.1 mol %.

In any embodiment described above, the glass composition may include tramp components, for example, Fe₂O₃, or SO₃. In such embodiments, Fe₂O₃ may be present in the glass composition in an amount less than or equal to 0.01 mol %, and SO₃ may be present in the glass composition in an amount less than or equal to 0.04 mol %.

Without limiting compositions possibly chosen from each of the various components recited above, in embodiments, the glass composition may comprise from greater than or equal to 68.5 mol % to less than or equal to 76.5 mol % SiO₂, from greater than or equal to 5.5 mol % to less than or equal to 11.0 mol % Al₂O₃, from greater than or equal to 9.0 mol % to less than or equal to 14.5 mol % Na₂O, from greater than or equal to 4.0 mol % to less than or equal to 5.7 mol % MgO, from greater than or equal to 1.0 mol % to less than or equal to 4.8 mol % CaO, from greater than or equal to 0.05 mol % to less than or equal to 3.9 mol % K₂O, less than or equal to 0.2 mol % SnO₂.

In embodiments, the glass composition may comprise from greater than or equal to 68.7 mol % to less than or equal to 73.0 mol % SiO₂, from greater than or equal to 7.7 mol % to less than or equal to 10.8 mol % Al₂O₃, from greater than or equal to 10.7 mol % to less than or equal to 13.7 mol % Na₂O, from greater than or equal to 4.4 mol % to less than or equal to 5.5 mol % MgO, from greater than or equal to 1.6 mol % to less than or equal to 3.5 mol % CaO, from greater than or equal to 0.1 mol % to less than or equal to 2.1 mol % K₂O, less than or equal to 0.18 mol % SnO₂.

In embodiments, the glass composition may comprise from greater than or equal to 69.0 mol % to less than or equal to 69.2 mol % SiO₂, from greater than or equal to 10.0 mol % to less than or equal to 10.7 mol % Al₂O₃, from greater than or equal to 12.5 mol % to less than or equal to 13.0 mol % Na₂O, from greater than or equal to 4.8 mol % to less than or equal to 5.2 mol % MgO, from greater than or equal to 2.2 mol % to less than or equal to 2.3 mol % CaO, from greater than or equal to 0.2 mol % to less than or equal to 0.4 mol % K₂O, less than or equal to 0.16 mol % SnO₂.

Without limiting compositions possibly chosen from each of the various components recited above, in embodiments, the glass composition may comprise alkali earth metal oxides (RO) that may include MgO and CaO, wherein the molar ratio of MgO to RO(MgO/RO) may be from greater than or equal to 0.5 to less than or equal to 0.8, such as greater than or equal to 0.5 to less than or equal to 0.7, greater than or equal to 0.5 to less than or equal to 0.6, greater than or equal to 0.6 to less than or equal to 0.8, greater than or equal to 0.6 to less than or equal to 0.7, or greater than or equal to 0.7 to less than or equal to 0.8.

In embodiments, the glass composition may comprise alkali earth metal oxides (RO) and alkali metal oxides (R₂O) that may include Na₂O and K₂O, wherein the sum of the mole percentage of RO and R₂O(RO+R₂O) may be from greater than or equal to 17.5 mol % to less than or equal to 21.0 mol %, such as from greater than or equal to 18.0 mol % to less than or equal to 20.0 mol %, or from greater than or equal to 18.5 mol % to less than or equal to 19.5 mol %. In embodiments, the glass composition may comprise RO, R₂O, and Al₂O₃, wherein the sum of the mole percentage of RO and R₂O minus the mole percentage of Al₂O₃((RO+R₂O)−Al₂O₃) may be from greater than or equal to 9.0 mol % to less than or equal to 13.0 mol %, such as from greater than or equal to 10.0 mol % to less than or equal to 12.0 mol %, or from greater than or equal to 10.5 mol % to less than or equal to 11.5 mol %. In embodiments, the glass composition may comprise RO, R₂O, and Al₂O₃, wherein the sum of mole percentage of RO and R₂O over the mole percentage of Al₂O₃((RO+R₂O)/Al₂O₃) may be from greater than or equal to 1.85 to less than or equal to 3.50, such as from greater than or equal to 2.00 to less than or equal to 3.0, or from greater than or equal to 2.25 to less than or equal to 2.75.

In embodiments, the glass composition may comprise RO and Al₂O₃, wherein the sum of the mole percentage of RO and the mole percentage of Al₂O₃ may be from greater than or equal to 13.0 mol % to less than or equal to 18.0 mol %, such as from greater than or equal to 13.5 mol % to less than or equal to 17.5 mol %, greater than or equal to 14.0 mol % to less than or equal to 17.0 mol %, greater than or equal to 14.5 mol % to less than or equal to 16.5 mol %, or greater than or equal to 15.0 mol % to less than or equal to 16.0 mol %.

As discussed above, alkali aluminosilicate glass compositions disclosed and described herein comprise a significant amount of SLG cullet, which allows for a large proportion of the alkali aluminosilicate glasses disclosed and described herein to be from post-consumer recycled material. However, the SLG cullet comprises a significant amount of calcium compared to other alkali aluminosilicate glasses that do not include a high proportion of post-consumer recycled glass material. This increased amount of calcium can increase the formability of the glass composition, but it hinders the diffusivity of ions during ion exchange processing. It has been found that adding certain amounts of potassium to the glass composition can aid in the diffusivity of ions into the glass during ion exchange. This presents itself in an improved DOL. However, if too much potassium is added to the glass composition the replacement of smaller ions (such as Na⁺) in the glass matrix with larger ions (such as K⁺) in the ion exchange bath will be hindered by the sheer number of potassium ions in the glass material. This will manifest itself as a decreased CS. Accordingly, it has been found that a balance of potassium and calcium in the glass composition can provide acceptable diffusivity-resulting in improved DOL—and compression—resulting in improved CS. Herein, this balance of calcium and potassium is shown by difference in mole percent of CaO and K₂O(CaO—K₂O).

In embodiments, difference in mole percent of CaO and K₂O may be from greater than or equal to −1.5 mol % to less than or equal to 4.8 mol %, such as from greater than or equal to −0.5 mol % to less than or equal to 4.8 mol %, greater than or equal to 0.0 mol % to less than or equal to 4.8 mol %, greater than or equal to 1.0 mol % to less than or equal to 4.8 mol %, greater than or equal to 2.0 mol % to less than or equal to 4.8 mol %, greater than or equal to 3.0 mol % to less than or equal to 4.8 mol %, greater than or equal to 4.0 mol % to less than or equal to 4.8 mol %, from greater than or equal to −1.5 mol % to less than or equal to 4.0 mol %, from greater than or equal to −0.5 mol % to less than or equal to 4.0 mol %, greater than or equal to 0.0 mol % to less than or equal to 4.0 mol %, greater than or equal to 1.0 mol % to less than or equal to 4.0 mol %, greater than or equal to 2.0 mol % to less than or equal to 4.0 mol %, greater than or equal to 3.0 mol % to less than or equal to 4.0 mol %, from greater than or equal to −1.5 mol % to less than or equal to 3.0 mol %, from greater than or equal to −0.5 mol % to less than or equal to 3.0 mol %, greater than or equal to 0.0 mol % to less than or equal to 3.0 mol %, greater than or equal to 1.0 mol % to less than or equal to 3.0 mol %, greater than or equal to 2.0 mol % to less than or equal to 3.0 mol %, from greater than or equal to −1.5 mol % to less than or equal to 2.0 mol %, from greater than or equal to −0.5 mol % to less than or equal to 2.0 mol %, greater than or equal to 0.0 mol % to less than or equal to 2.0 mol %, greater than or equal to 1.0 mol % to less than or equal to 2.0 mol %, from greater than or equal to −1.5 mol % to less than or equal to 1.0 mol %, from greater than or equal to −0.5 mol % to less than or equal to 1.0 mol %, greater than or equal to 0.0 mol % to less than or equal to 1.0 mol %, from greater than or equal to −1.5 mol % to less than or equal to 0.0 mol %, from greater than or equal to −0.5 mol % to less than or equal to 0.0 mol %, or from greater than or equal to −1.5 mol % to less than or equal to −0.5 mol %.

In embodiments, the glass composition may comprise R₂O and CaO, wherein the mole percentage of R₂O minus the mole percentage of CaO(R₂O—CaO) may be from greater than or equal to 9.0 mol % to less than or equal to 15.0 mol %, such as from greater than or equal to 9.5 mol % to less than or equal to 14.5 mol %, from greater than or equal to 10.0 mol % to less than or equal to 14.0 mol %, from greater than or equal to 10.5 mol % to less than or equal to 13.5 mol %, from greater than or equal to 11.0 mol % to less than or equal to 13.0 mol %, or from greater than or equal to 11.5 mol % to less than or equal to 12.5 mol %.

Physical properties of alkali aluminosilicate glass compositions as disclosed above will now be discussed. The properties discussed below show the results of adding calcium to alkali aluminosilicate glasses. These physical properties can be achieved by modifying the component amounts of the Ca containing aluminosilicate glass composition, as will be discussed in more detail with reference to the examples.

The density of the glass compositions was determined using the buoyancy method of ASTM C693-93(2013). Glass compositions according to embodiments may have a density from greater than or equal to 2.40 g/cm³ to less than or equal to 2.45 g/cm³, such as from greater than or equal to 2.41 g/cm³ to less than or equal to 2.45 g/cm³, from greater than or equal to 2.42 g/cm³ to less than or equal to 2.45 g/cm³, from greater than or equal to 2.43 g/cm³ to less than or equal to 2.45 g/cm³, or from greater than or equal to 2.44 g/cm³ to less than or equal to 2.45 g/cm³. In embodiments, the glass compositions may have a density of about 2.40 g/cm³, about 2.41 g/cm³, about 2.42 g/cm³, about 2.43 g/cm³, about 2.44 g/cm³, or about 2.45 g/cm³. In embodiments, the glass composition may have a density from greater than or equal to 2.44 g/cm³ to 2.45 g/cm³.

The term “strain point,” as used herein, refers to the temperature at which the viscosity of the glass composition is 1×1014.68 poise. The strain point of the glass compositions was determined using the fiber elongation method of ASTM C336-71(2015). In embodiments, the strain point of glass compositions may be from greater than or equal to 570° C. to less than or equal to 620° C., such as from greater than or equal to 575° C. to less than or equal to 615° C., from greater than or equal to 580° C. to less than or equal to 610° C., from greater than or equal to 585° C. to less than or equal to 605° C., or from greater than or equal to 590° C. to less than or equal to 600° C. In embodiments, the strain point of the glass composition may be from greater than or equal to 570° C. to less than or equal to 620° C., such as from greater than or equal to 580° C. to less than or equal to 620° C., from greater than or equal to 590° C. to less than or equal to 620° C., from greater than or equal to 600° C. to less than or equal to 620° C., or from greater than or equal to 610° C. to less than or equal to 620° C. In embodiments, the strain point of the glass composition may be from greater than or equal to 570° C. to less than or equal to 610° C., from greater than or equal to 570° C. to less than or equal to 600° C., from greater than or equal to 570° C. to less than or equal to 590° C., or from greater than or equal to 570° C. to less than or equal to 580° C. In embodiments, the glass composition may have a strain point of glass from greater than or equal to 600° C. to 620° C.

The term “annealing point,” as used herein, refers to the temperature at which the viscosity of the glass composition is 1×10^{130.18} poise. The annealing point of the glass compositions was determined using the fiber elongation method of ASTM C336-71(2015). In embodiments, the annealing point of glass compositions may be from greater than or equal to 620° C. to less than or equal to 670° C., such as from greater than or equal to 630° C. to less than or equal to 660° C., or from greater than or equal to 640° C. to less than or equal to 650° C. In embodiments, the annealing point of the glass composition may be from greater than or equal to 630° C. to less than or equal to 670° C., from greater than or equal to 640° C. to less than or equal to 670° C., from greater than or equal to 650° C. to less than or equal to 670° C., or from greater than or equal to 660° C. to less than or equal to 670° C. In embodiments, the glass composition may have an annealing point of glass from greater than or equal to 650° C. to 670° C.

The term “softening point,” as used herein, refers to the temperature at which the viscosity of the glass composition is 1×10^{7.6} poise. The softening point of the glass compositions was determined using the fiber elongation method of ASTM C336-71(2015). In embodiments, the softening point of glass compositions may be from greater than or equal to 875° C. to less than or equal to 915° C., such as from greater than or equal to 880° C. to less than or equal to 910° C., from greater than or equal to 885° C. to less than or equal to 905° C., or from greater than or equal to 890° C. to less than or equal to 900° C. In embodiments, the softening point of the glass composition may be from greater than or equal to 890° C. to less than or equal to 915° C., such as from greater than or equal to 895° C. to less than or equal to 910° C., or from greater than or equal to 900° C. to less than or equal to 905° C. In embodiments, the glass composition may have a softening point of glass from greater than or equal to 890° C. to 915° C.

The linear coefficient of thermal expansion (CTE) over the temperature range 0-300° C. was determined using a push-rod dilatometer in accordance with ASTM E228-11. In embodiments, the CTE of the glass composition may be from greater than or equal to 60.0×10⁻⁷/K to less than or equal to 85.0×10⁻⁷/K, such as from greater than or equal to 65×10⁻⁷/K to less than or equal to 80×10⁻⁷/K, or from greater than or equal to 70×10⁻⁷/K to less than or equal to 75×10⁻⁷/K. In embodiments, the glass composition may have a CTE from greater than or equal to 65.0×10⁻⁷/K to less than or equal to 85.0×10⁻⁷/K, from greater than or equal to 70.0×10⁻⁷/K to less than or equal to 85.0×10⁻⁷/K, from greater than or equal to 75.0×10⁻⁷/K to less than or equal to 85.0×10⁻⁷/K, or from greater than or equal to 80.0×10⁻⁷/K to less than or equal to 85.0×10⁻⁷/K. In embodiments, the glass composition has a CTE from the glass composition may have a CTE from greater than or equal to 65.0×10⁻⁷/K to less than or equal to 85.0×10⁻⁷/K, the glass composition may have a CTE from greater than or equal to 65.0×10⁻⁷/K to less than or equal to 80.0×10⁻⁷/K, the glass composition may have a CTE from greater than or equal to 65.0×10⁻⁷/K to less than or equal to 75.0×10⁻⁷/K, or the glass composition may have a CTE from greater than or equal to 65.0×10⁻⁷/K to less than or equal to 70.0×10⁻⁷/K. In embodiments, the glass composition may have a CTE from greater than or equal to 75.0×10⁻⁷/K to 77.0×10⁻⁷/K.

The Poisson's ratio (v), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.” In embodiments, the Young's modulus of a glass composition may be from greater than or equal to 72.0 GPa to less than or equal to 75.0 GPa, such as from greater than or equal to 72.2 GPa to less than or equal to 74.8 GPa, or from greater than or equal to 72.4 GPa to less than or equal to 74.6 GPa, from greater than or equal to 72.6 GPa to less than or equal to 74.4 GPa, from greater than or equal to 72.8 GPa to less than or equal to 74.2 GPa, from greater than or equal to 73.0 GPa to less than or equal to 74.0 GPa, from greater than or equal to 73.2 GPa to less than or equal to 73.8 GPa, or from greater than or equal to 73.4 GPa to less than or equal to 73.6 GPa. In embodiments, the Young's modulus of the glass composition may be from greater than or equal to 72.5 GPa to less than or equal to 75.0 GPa, from greater than or equal to 73.0 GPa to less than or equal to 75.0 GPa, from greater than or equal to 73.5 GPa to less than or equal to 75.0 GPa, from greater than or equal to 74.0 GPa to less than or equal to 75.0 GPa, or from greater than or equal to 74.5 GPa to less than or equal to 75.0 GPa. In embodiments, the Young's modulus may be from greater than or equal to 72.0 GPa to less than or equal to 74.5 GPa, from greater than or equal to 72.0 GPa to less than or equal to 74.0 GPa, from greater than or equal to 72.0 GPa to less than or equal to 73.5 GPa, from greater than or equal to 72.0 GPa to less than or equal to 73.0 GPa, or from greater than or equal to 72.0 GPa to less than or equal to 72.5 GPa. In embodiments, the glass composition may have a Young's modulus from greater than or equal to 73.5 GPa to 74.0 GPa.

According to embodiments, the glass composition may have a shear modulus of from greater than or equal to 29.0 GPa to less than or equal to 31.5 GPa, such as from greater than or equal to 29.5 GPa to less than or equal to 31.0 GPa, or from greater than or equal to 30.0 GPa to less than or equal to 30.5 GPa. In embodiments the glass composition may have a shear modulus from greater than or equal to 29.5 GPa to less than or equal to 31.5 GPa, from greater than or equal to 30.0 GPa to less than or equal to 31.5 GPa, from greater than or equal to 30.5 GPa to less than or equal to 31.5 GPa, or from greater than or equal to 31.0 GPa to less than or equal to 31.5 GPa. In embodiments, the glass composition may have a shear modulus from greater than or equal to 29.0 GPa to less than or equal to 31.0 GPa, from greater than or equal to 29.0 GPa to less than or equal to 30.5 GPa, from greater than or equal to 29.0 GPa to less than or equal to 30.0 GPa, or from greater than or equal to 29.0 GPa to less than or equal to 29.5 GPa. In embodiments, the glass composition may have a shear modulus from greater than or equal to 30.5 GPa to 31.0 GPa.

According to embodiments, the glass composition may have a Poisson's ratio of from greater than or equal to 0.195 to less than or equal to 0.210, such as from greater than or equal to 0.200 to less than or equal to 0.205. In embodiments, the Poisson's ratio of the glass composition is from greater than or equal to 0.200 to less than or equal to 0.210, or from greater than or equal to 0.205 to less than or equal to 0.210. In embodiments, the Poisson's ratio of the glass composition is from greater than or equal to 0.195 to less than or equal to 0.205, or from greater than or equal to 0.195 to less than or equal to 0.200. In embodiments, the glass composition may have a Young's modulus from greater than or equal to 0.200 to 0.210.

The glass compositions described herein may be selected to have liquidus viscosities that are compatible with fusion draw processes. Thus, the glass compositions described herein are compatible with existing forming methods, increasing the manufacturability of glass-based articles formed from the glass compositions. As used herein, the term “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed in this application is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. The term “Vogel-Fulcher-Tamman (‘VFT’) relation,” as used herein, described the temperature dependence of the viscosity and is represented by the following equation log n=A+B/(T−T₀), where n is viscosity. To determine VFT A, VFT B, and VFT To, the viscosity of the glass composition is measured over a given temperature range. The raw data of viscosity versus temperature is then fit with the VFT equation by least-squares fitting to obtain A, B, and T₀. With these values, a viscosity point (e.g., 200 P Temperature, 35000 P Temperature, and 200000 P Temperature) at any temperature above softening point may be calculated. Unless otherwise specified, the liquidus viscosity and temperature of a glass composition or article is measured before the composition or article is subjected to any ion-exchange process or any other strengthening process. In particular, the liquidus viscosity and temperature of a glass composition or article is measured before the composition or article is exposed to an ion-exchange solution, for example before being immersed in an ion-exchange solution. Where an ion exchanged article is described as having a liquidus viscosity, the reference is to the liquidus viscosity of the article prior to ion exchange. The pre-ion exchange composition may be determined by looking at the composition at the center of the article.

According to embodiments, the glass composition may have a liquidus temperature of from greater than or equal to 995° C. to less than or equal to 1175° C., such as from greater than or equal to 1000° C. to less than or equal to 1150° C., from greater than or equal to 1025° C. to less than or equal to 1125° C., or from greater than or equal to 1050° C. to less than or equal to 1100° C. In embodiments, the liquidus temperature of the glass composition is from greater than or equal to from greater than or equal to 1000° C. to less than or equal to 1175° C., such as from greater than or equal to 1025° C. to less than or equal to 1175° C., from greater than or equal to 1050° C. to less than or equal to 1175° C., from greater than or equal to 1075° C. to less than or equal to 1175° C., from greater than or equal to 1100° C. to less than or equal to 1175° C., from greater than or equal to 1125° C. to less than or equal to 1175° C., or from greater than or equal to 1150° C. to less than or equal to 1175° C. In embodiments, the liquidus temperature of the glass composition is from greater than or equal to from greater than or equal to 995° C. to less than or equal to 1150° C., such as from greater than or equal to 995° C. to less than or equal to 1125° C., from greater than or equal to 995° C. to less than or equal to 1100° C., from greater than or equal to 995° C. to less than or equal to 1050° C., from greater than or equal to 995° C. to less than or equal to 1025° C., or from greater than or equal to 995° C. to less than or equal to 1000° C. In embodiments, the glass composition may have a liquidus temperature from greater than or equal to 1085° C. to 1095° C.

The liquidus viscosity of the glass compositions, according to embodiments, is from greater than or equal to 45 kPa to less than or equal to 2065 kPa, such as from greater than or equal to 50 kPa to less than or equal to 2000 kPa, from greater than or equal to 100 kPa to less than or equal to 1800 kPa, from greater than or equal to 300 kPa to less than or equal to 1600 kPa, from greater than or equal to 500 kPa to less than or equal to 1400 kPa, from greater than or equal to 700 kPa to less than or equal to 1200 kPa, or from greater than or equal to 900 kPa to less than or equal to 1000 kPa. In embodiments, the liquidus viscosity of the glass compositions may be from greater than or equal to 50 kPa to less than or equal to 2050 kPa, such as from greater than or equal to 300 kPa to less than or equal to 2050 kPa, from greater than or equal to 500 kPa to less than or equal to 2050 kPa, from greater than or equal to 700 kPa to less than or equal to 2050 kPa, from greater than or equal to 900 kPa to less than or equal to 2050 kPa, from greater than or equal to 1100 kPa to less than or equal to 2050 kPa, from greater than or equal to 1300 kPa to less than or equal to 2050 kPa, from greater than or equal to 1500 kPa to less than or equal to 2050 kPa, from greater than or equal to 1700 kPa to less than or equal to 2050 kPa, or from greater than or equal to 1900 kPa to less than or equal to 2050 kPa. In embodiments, the liquidus viscosity of the glass compositions may be from greater than or equal to 45 kPa to less than or equal to 2050 kPa, such as from greater than or equal to 45 kPa to less than or equal to 2050 kPa, from greater than or equal to 45 kPa to less than or equal to 1850 kPa, from greater than or equal to 45 kPa to less than or equal to 1650 kPa, from greater than or equal to 45 kPa to less than or equal to 1450 kPa, from greater than or equal to 45 kPa to less than or equal to 1250 kPa, from greater than or equal to 45 kPa to less than or equal to 1050 kPa, from greater than or equal to 45 kPa to less than or equal to 850 kPa, from greater than or equal to 45 kPa to less than or equal to 650 kPa, from greater than or equal to 45 kPa to less than or equal to 450 kPa, from greater than or equal to 45 kPa to less than or equal to 250 kPa, or from greater than or equal to 45 kPa to less than or equal to 50 kPa. In embodiments, the glass composition may have a liquidus viscosity from greater than or equal to 175 kPa to 270 kPa.

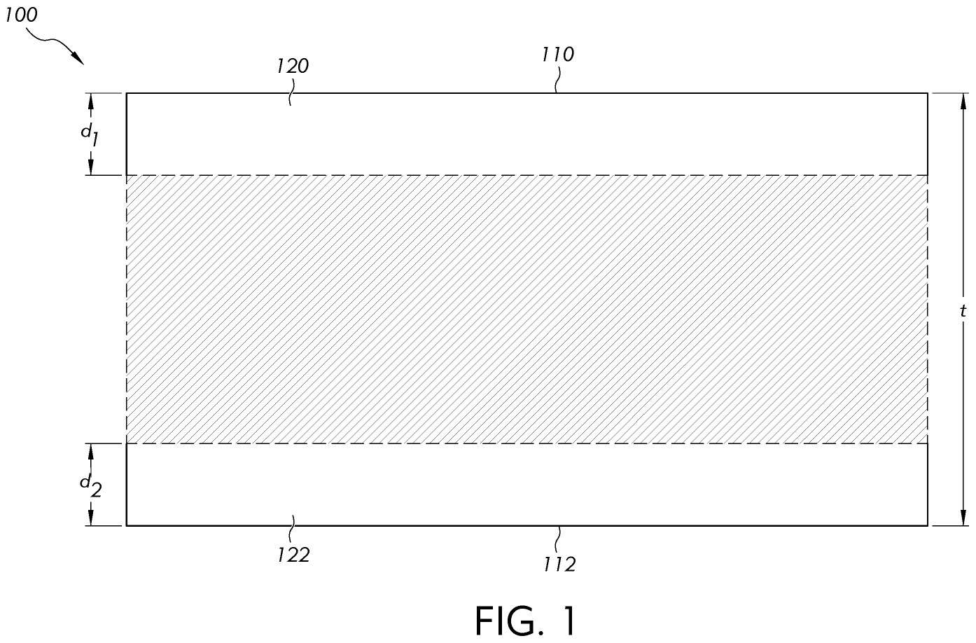

As mentioned above, in embodiments, the alkali aluminosilicate glass compositions can be strengthened, such as by ion exchange, making a glass that is damage resistant for applications such as, but not limited to, cover glasses and digital screens. With reference to FIG. 1, the glass has a first region under compressive stress (e.g., first and second compressive layers 120, 122 in FIG. 1) extending from the surface to a depth of layer DOL of the glass and a second region (e.g., central region 130 in FIG. 1) under a tensile stress or central tension CT extending from the depth of layer into the central or interior region of the glass.

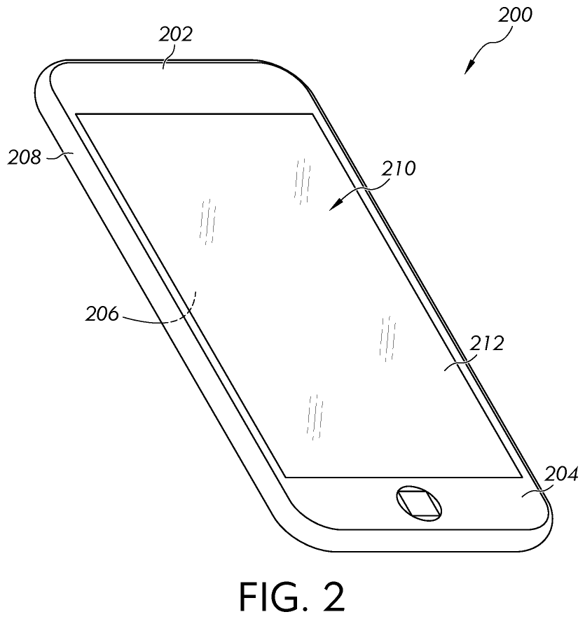

“Peak compressive stress,” as used herein, refers to the highest compressive stress (CS) value measured within a compressive stress region. The CS has a maximum at the surface of the glass, and the CS varies with distance d from the surface according to a function, such as the compressive stress function shown in FIG. 2. Referring again to FIG. 1, a first segment 120 extends from first surface 110 to a depth d₁ and a second segment 122 extends from second surface 112 to a depth d₂. Together, these segments define a surface compression or surface CS of glass 100. The surface CS may be from greater or equal to 400 MPa to less than or equal to 1000 MPa. In embodiments, the surface CS may be at least 400 MPa, such as at least 450 MPa, at least 500 MPa, at least 550 MPa, at least 600 MPa, at least 650 MPa, at least 675 MPa, at least 700 MPa, at least 725 MPa, at least 750 MPa, at least 775 MPa, at least 800 MPa, at least 825 MPa, at least 850 MPa, at least 875 MPa, at least 900 MPa, at least 925 MPa, at least 950 MPa, or at least 975 MPa. In embodiments, the surface CS is less than or equal to 1000 MPa, such as less than or equal to 975 MPa, less than or equal to 950 MPa, less than or equal to 925 MPa, less than or equal to 900 MPa, less than or equal to 875 MPa, less than or equal to 850 MPa, less than or equal to 825 MPa, less than or equal to 800 MPa, less than or equal to 775 MPa, less than or equal to 750 MPa, less than or equal to 725 MPa, less than or equal to 700 MPa, less than or equal to 675 MPa, less than or equal to 650 MPa, less than or equal to 600 MPa, less than or equal to 550 MPa, less than or equal to 500 MPa, or less than or equal to 450 MPa. In embodiments, the surface CS may be from greater than or equal to 450 MPa to less than or equal to 950 MPa, such as from greater than or equal to 500 MPa to less than or equal to 900 MPa, from greater than or equal to 550 MPa to less than or equal to 850 MPa, from greater than or equal to 600 MPa to less than or equal to 800 MPa, or from greater than or equal to 650 MPa to less than or equal to 750 MPa.

Depth of layer” (DOL), as used herein, refers to the depth within a glass article at which an ion of a metal oxide diffuses into the glass article where the concentration of the ion reaches a minimum value. The depth of layer DOL of each of first and second compressive layers 120, 122 may be from greater than or equal to 4.0 μm to less than or equal to 56.5 μm, such as from greater than or equal to 5.0 μm to less than or equal to 55 μm, from greater than or equal to 10.0 μm to less than or equal to 50.0 μm, from greater than or equal to 15.0 μm to less than or equal to 45.0 μm, from greater than or equal to 20 μm to less than or equal to 40.0 μm, or from greater than or equal to 25.0 μm to less than or equal to 35.0 μm. In embodiments, the DOL of each of the first and second compressive layers 120, 122 is from greater than or equal to 5.0 μm to less than or equal to 56.5 μm, from greater than or equal to 10.0 μm to less than or equal to 56.5 μm, from greater than or equal to 15.0 μm to less than or equal to 56.5 μm, from greater than or equal to 20.0 μm to less than or equal to 56.5 μm, from greater than or equal to 25.0 μm to less than or equal to 56.5 μm, from greater than or equal to 30.0 μm to less than or equal to 56.5 μm, from greater than or equal to 35.0 μm to less than or equal to 56.5 μm, from greater than or equal to 40.0 μm to less than or equal to 56.5 μm, from greater than or equal to 45.0 μm to less than or equal to 56.5 μm, or from greater than or equal to 50.0 μm to less than or equal to 56.5 μm. In embodiments, the DOL of each of the first and second compressive layers 120, 122 is from greater than or equal to 4.0 μm to less than or equal to 55.0 μm, from greater than or equal to 4.0 μm to less than or equal to 50.0 μm, from greater than or equal to 4.0 μm to less than or equal to 45.0 μm, from greater than or equal to 4.0 μm to less than or equal to 40.0 μm, from greater than or equal to 4.0 μm to less than or equal to 35.0 μm, from greater than or equal to 4.0 μm to less than or equal to 30.0 μm, from greater than or equal to 4.0 μm to less than or equal to 25.0 μm, from greater than or equal to 4.0 μm to less than or equal to 20.0 μm, from greater than or equal to 4.0 μm to less than or equal to 15.0 μm, from greater than or equal to 4.0 μm to less than or equal to 10.0 μm, or from greater than or equal to 4.0 μm to less than or equal to 5.0 μm.

Compressive stress layers may be formed in the glass by exposing the glass to an ion exchange solution. In embodiments, the ion exchange solution may be molten nitrate salts or molten sulfate salts. In embodiments, the ion exchange solution may be molten KNO₃, molten NaNO₃, or combinations thereof. In certain embodiments, the ion exchange solution may comprise about 100% molten KNO₃.

The glass composition may be exposed to the ion exchange solution by dipping a glass article made from the glass composition into a bath of the ion exchange solution, spraying the ion exchange solution onto a glass article made from the glass composition, or otherwise physically applying the ion exchange solution to a glass article made from the glass composition. Upon exposure to the glass composition, the ion exchange solution may, according to embodiments, be at a temperature from greater than or equal to 380° C. to less than or equal to 450° C., such as from greater than or equal to 385° C. to less than or equal to 445° C., from greater than or equal to 390° C. to less than or equal to 440° C., from greater than or equal to 395° C. to less than or equal to 435° C., from greater than or equal to 400° C. to less than or equal to 430° C., from greater than or equal to 405° C. to less than or equal to 425° C., or from greater than or equal to 410° C. to less than or equal to 420° C. In embodiments, the glass composition may be exposed to the ion exchange solution for a duration from greater than or equal to 2 hours to less than or equal to 8 hours, such as from greater than or equal to 3 hours to less than or equal to 7 hours, or from greater than or equal to 4 hours to less than or equal to 6 hours.

The glass articles made from the glass compositions disclosed herein may be incorporated into another article, for example an article with a display (or display articles) (e.g., consumer electronics, including mobile phones, watches, tablets, computers, navigation systems, and the like), architectural articles, transportation articles (e.g., automobiles, trains, aircraft, sea craft, etc.), appliance articles, or any article that may benefit from some transparency, scratch-resistance, abrasion resistance or a combination thereof. An exemplary article incorporating any of the glass articles disclosed herein is shown in FIG. 2. Specifically, FIG. 2 shows a consumer electronic product 200 including a housing 202 having a front surface 204, a back surface 206, and side surfaces 208. A display 210, for example, a light emitting diode (LED) display or an organic light emitting diode (OLED) display, is at least partially inside the housing 202. A cover substrate 212 may be disposed at or over front surface 204 of housing 202 such that it is disposed over display 210. Cover substrate 212 may include any of the glass articles made from the glass compositions disclosed herein. Cover substrate 212 may serve to protect display 210 and other components of consumer electronic product 200 from damage. In embodiments, cover substrate 212 may be bonded to display 210 with an adhesive. In embodiments, cover substrate 212 may define all or a portion of front surface 204 of housing 202. In some embodiments, cover substrate 212 may define front surface 204 of housing 202 and all or a portion of side surfaces 208 of housing 202.

According to a first clause an alkali aluminosilicate glass article comprising: from greater than or equal to 68.5 mol % to less than or equal to 76.5 mol % SiO₂; from greater than or equal to 5.5 mol % to less than or equal to 11.0 mol % Al₂O₃; from greater than or equal to 9.0 mol % to less than or equal to 14.5 mol % Na₂O; from greater than or equal to 4.0 mol % to less than or equal to 5.7 mol % MgO; from greater than or equal to 1.0 mol % to less than or equal to 4.8 mol % CaO; from greater than or equal to 0.05 mol % to less than or equal to 3.9 mol % K₂O; and wherein CaO mol %−K₂O mol % is greater than or equal to −1.5 mol % and less than or equal to 4.8 mol %.

A second clause includes the glass article according to the first clause, wherein the glass article comprises: from greater than or equal to 68.7 mol % to less than or equal to 73.0 mol % SiO₂; from greater than or equal to 7.7 mol % to less than or equal to 10.8 mol % Al₂O₃; from greater than or equal to 10.7 mol % to less than or equal to 13.7 mol % Na₂O; from greater than or equal to 4.4 mol % to less than or equal to 5.5 mol % MgO; from greater than or equal to 1.6 mol % to less than or equal to 3.5 mol % CaO; from greater than or equal to 0.1 mol % to less than or equal to 2.1 mol % K₂O; and wherein CaO mol %−K₂O mol % is greater than or equal to 0.2 mol % and less than or equal to 3.4 mol %.

A third clause includes the glass article of one of the first to second clauses, wherein the glass article comprises: from greater than or equal to 69.0 mol % to less than or equal to 69.2 mol % SiO₂; from greater than or equal to 10.0 mol % to less than or equal to 10.7 mol % Al₂O₃; from greater than or equal to 12.5 mol % to less than or equal to 13.0 mol % Na₂O; from greater than or equal to 4.8 mol % to less than or equal to 5.2 mol % MgO; from greater than or equal to 2.2 mol % to less than or equal to 2.3 mol % CaO; from greater than or equal to 0.2 mol % to less than or equal to 0.4 mol % K₂O; and wherein CaO mol %−K₂O mol % is greater than or equal to 1.9 mol % and less than or equal to 2.1 mol %.

A fourth clause includes the glass article of any one of the first to third clauses, wherein a molar ratio of MgO to RO is greater than or equal to 0.5 and less than or equal to 0.8, wherein RO is the sum of alkaline earth metals in the glass article.

A fifth clause includes the glass article of any one of the first to fourth clauses, wherein the sum of RO and R₂O is greater than or equal to 17.5 mol % and less than or equal to 21.0 mol %, wherein RO is the sum of alkaline earth metals in the glass article and R₂O is the sum of alkali metals in the glass article.

A sixth clause includes the glass article of any one of the first to fifth clauses, wherein RO mol %+Al₂O₃ mol % is greater than or equal to 13.0 mol % and less than or equal to 18.0 mol %.

A seventh clause includes the glass article of any one of the first to sixth clauses, wherein (RO mol %+R₂O mol %)−Al₂O₃ mol % is greater than or equal to 9.0 mol % and less than or equal to 13.0 mol %.

A eighth clause includes the glass article of any one of the first to seventh clauses, wherein (RO mol %+R₂O mol %)/Al₂O₃ mol % is greater than or equal to 1.85 and less than or equal to 3.50.

A ninth clause includes the glass article of any one of the first to eighth clauses, wherein R₂O mol %-CaO mol % is greater than or equal to 9.0 mol % and less than or equal to 15.0 mol %.

A tenth clause includes the glass article of any one of the first to ninth clauses, wherein the glass article comprises a liquidus viscosity in a range of 45 kPa to 2065 kPa.

A eleventh clause includes the glass article of any one of the first to tenth clauses, wherein the glass article comprises a Young's modulus value in a range of 72.0 MPa to 75.0 MPa.

A twelfth clause includes the glass article of any one of the first to eleventh clauses, wherein the glass article is substantially free of B₂O₃, P₂O₅, and Li₂O.

A thirteenth clause includes the glass article of the first to twelfth clauses, wherein the glass article comprises less than or equal to 0.2 mol % SnO₂.

A fourteenth clause includes an ion-exchange strengthened alkali aluminosilicate glass article comprising: from greater than or equal to 68.5 mol % to less than or equal to 76.5 mol % SiO₂; from greater than or equal to 5.5 mol % to less than or equal to 11.0 mol % Al₂O₃; from greater than or equal to 9.0 mol % to less than or equal to 14.5 mol % Na₂O; from greater than or equal to 4.0 mol % to less than or equal to 5.7 mol % MgO; from greater than or equal to 1.0 mol % to less than or equal to 4.8 mol % CaO; from greater than or equal to 0.05 mol % to less than or equal to 3.9 mol % K₂O; wherein CaO mol %−K₂O mol % is greater than or equal to −1.5 mol % and less than or equal to 4.8 mol %; and wherein the ion-exchange strengthened glass has one or more compressed surface layers.

A fifteenth clause includes the ion-exchange strengthened alkali aluminosilicate glass article of the fourteenth clause, wherein the glass article comprises: from greater than or equal to 68.7 mol % to less than or equal to 73.0 mol % SiO₂; from greater than or equal to 7.7 mol % to less than or equal to 10.8 mol % Al₂O₃; from greater than or equal to 10.7 mol % to less than or equal to 13.7 mol % Na₂O; from greater than or equal to 4.4 mol % to less than or equal to 5.5 mol % MgO; from greater than or equal to 1.6 mol % to less than or equal to 3.5 mol % CaO; from greater than or equal to 0.1 mol % to less than or equal to 2.1 mol % K₂O; and wherein CaO mol %−K₂O mol % is greater than or equal to 0.2 mol % and less than or equal to 3.4 mol %.

A sixteenth clause includes the ion-exchange strengthened alkali aluminosilicate glass article of one of the fourteenth to fifteenth clauses, wherein the glass article comprises: from greater than or equal to 69.0 mol % to less than or equal to 69.2 mol % SiO₂; from greater than or equal to 10.0 mol % to less than or equal to 10.7 mol % Al₂O₃; from greater than or equal to 12.5 mol % to less than or equal to 13.0 mol % Na₂O; from greater than or equal to 4.8 mol % to less than or equal to 5.2 mol % MgO; from greater than or equal to 2.2 mol % to less than or equal to 2.3 mol % CaO; from greater than or equal to 0.2 mol % to less than or equal to 0.4 mol % K₂O; and wherein CaO mol %−K₂O mol % is greater than or equal to 1.9 mol % and less than or equal to 2.1 mol %.

A seventeenth clause includes the ion-exchange strengthened alkali aluminosilicate glass article of any one of the fourteenth to sixteenth clauses, wherein the glass article is made from raw materials comprising at least soda-lime glass cullet.

A eighteenth clause includes the ion-exchange strengthened alkali aluminosilicate glass article of any one of the fourteenth to seventeenth clauses, wherein the glass article comprises a compressive stress in a range of 400 MPa to 1000 MPa.

A nineteenth clause includes the ion-exchange strengthened alkali aluminosilicate glass article of any one of the fourteenth to eighteenth clauses, wherein the glass article comprises a depth of length in a range of 4.0 μm to 56.5 μm.

A twentieth clause includes an electronic device comprise a housing, a display, a cover substrate adjacent to the display, wherein the cover substrate comprises the glass article of any one of the fourteenth to nineteenth clauses.

### EXAMPLES

Embodiments will be further clarified by the following examples. It should be understood that these examples are not limiting to the embodiments described above.

### Example 1

Glass Samples 1-41 were formed from compositions provided in TABLE 1 below. All these compositions were formed by a simple melt-quench technique in platinum crucibles. Constituents were melted for 6 hours at 1625° C., poured into water to be drigaged, reloaded into the crucibles and then melted for an additional 12 hours at 1650° C. and then poured onto a steel plate. The glasses were annealed at about 650° C. before going on to additional process.

TABLE 1

| | mol % | | | | | | | |
|---|---|---|---|---|---|---|---|---|
| Sample | SiO₂ | Al₂O₃ | MgO | CaO | Na₂O | K₂O | SnO₂ | Fe₂O₃ |
| 1 | 73.36 | 7.19 | 5.62 | 3.74 | 9.54 | 0.39 | 0.15 | 0.01 |
| 2 | 73.04 | 7.31 | 5.13 | 4.11 | 9.98 | 0.28 | 0.15 | 0.01 |
| 3 | 72.80 | 7.41 | 4.60 | 4.48 | 10.38 | 0.16 | 0.15 | 0.01 |
| 4 | 73.80 | 7.06 | 4.90 | 4.77 | 9.08 | 0.22 | 0.15 | 0.01 |
| 5 | 73.36 | 7.15 | 5.39 | 4.19 | 9.50 | 0.24 | 0.16 | 0.01 |
| 6 | 72.81 | 7.10 | 5.14 | 4.68 | 9.76 | 0.35 | 0.16 | 0.01 |
| 7 | 70.71 | 8.89 | 5.09 | 2.46 | 12.12 | 0.56 | 0.16 | 0.01 |
| 8 | 70.72 | 8.89 | 5.02 | 2.48 | 11.87 | 0.85 | 0.15 | 0.01 |
| 9 | 70.9 | 8.78 | 4.92 | 2.40 | 12.30 | 0.53 | 0.16 | 0.01 |
| 10 | 70.85 | 8.86 | 4.77 | 2.41 | 12.39 | 0.56 | 0.15 | 0.01 |
| 11 | 70.73 | 8.97 | 4.67 | 2.47 | 12.44 | 0.56 | 0.15 | 0.01 |
| 12 | 70.74 | 9.06 | 4.55 | 2.41 | 12.49 | 0.58 | 0.15 | 0.01 |
| 13 | 69.05 | 9.83 | 4.97 | 2.48 | 12.65 | 0.85 | 0.15 | 0.01 |
| 14 | 69.11 | 9.84 | 4.81 | 2.48 | 12.77 | 0.83 | 0.15 | 0.01 |
| 15 | 69.28 | 9.80 | 4.96 | 1.97 | 12.95 | 0.87 | 0.15 | 0.01 |
| 16 | 69.44 | 9.82 | 4.79 | 1.75 | 13.25 | 0.78 | 0.15 | 0.01 |
| 17 | 69.67 | 9.75 | 4.61 | 1.81 | 13.05 | 0.94 | 0.15 | 0.01 |
| 18 | 69.68 | 9.81 | 4.24 | 2.14 | 13.12 | 0.85 | 0.15 | 0.01 |
| 19 | 68.84 | 10.45 | 5.42 | 1.45 | 13.55 | 0.08 | 0.15 | 0.01 |
| 20 | 69.57 | 10.34 | 4.40 | 1.08 | 14.29 | 0.17 | 0.15 | 0.01 |
| 21 | 69.06 | 10.07 | 5.15 | 2.34 | 12.93 | 0.29 | 0.15 | 0.01 |
| 22 | 69.97 | 9.86 | 4.58 | 1.34 | 13.84 | 0.24 | 0.15 | 0.01 |
| 23 | 69.94 | 9.71 | 4.99 | 1.62 | 13.50 | 0.07 | 0.15 | 0.01 |
| 24 | 70.38 | 9.69 | 4.04 | 2.38 | 13.26 | 0.08 | 0.15 | 0.01 |
| 25 | 76.12 | 5.74 | 5.00 | 2.46 | 10.27 | 0.22 | 0.16 | 0.01 |
| 26 | 75.19 | 6.38 | 4.92 | 2.41 | 10.70 | 0.22 | 0.15 | 0.01 |
| 27 | 72.81 | 7.95 | 4.99 | 2.46 | 11.40 | 0.22 | 0.15 | 0.01 |
| 28 | 71.10 | 9.18 | 4.85 | 2.45 | 12.02 | 0.22 | 0.15 | 0.01 |
| 29 | 71.57 | 9.07 | 4.88 | 2.97 | 11.12 | 0.22 | 0.15 | 0.01 |
| 30 | 69.19 | 10.65 | 4.89 | 2.24 | 12.54 | 0.33 | 0.15 | 0.01 |
| 31 | 69.54 | 10.33 | 4.56 | 2.50 | 11.55 | 1.36 | 0.16 | 0.01 |
| 32 | 69.15 | 10.63 | 4.44 | 2.50 | 11.79 | 1.33 | 0.16 | 0.01 |
| 33 | 69.85 | 10.19 | 4.63 | 2.50 | 10.90 | 1.77 | 0.16 | 0.01 |
| 34 | 68.96 | 9.9 | 4.58 | 2.44 | 10.09 | 3.87 | 0.15 | 0.01 |
| 35 | 69.69 | 10.39 | 4.56 | 2.5 | 10.47 | 2.23 | 0.15 | 0.01 |
| 36 | 69.34 | 10.33 | 4.67 | 2.49 | 11.51 | 1.51 | 0.15 | 0.01 |
| 37 | 68.91 | 10.65 | 4.52 | 2.48 | 11.76 | 1.50 | 0.15 | 0.01 |
| 38 | 69.62 | 10.2 | 4.71 | 2.47 | 10.81 | 2.01 | 0.15 | 0.01 |
| 39 | 69.28 | 10.5 | 4.55 | 2.46 | 11.04 | 2.00 | 0.15 | 0.01 |
| 40 | 69.93 | 10.07 | 4.72 | 2.47 | 10.17 | 2.47 | 0.15 | 0.01 |
| 41 | 69.49 | 10.38 | 4.62 | 2.46 | 10.39 | 2.48 | 0.16 | 0.01 |

Various measured properties of Samples 1-41 are provided below in TABLE 2.

TABLE 2

| | | | | | | | | | Liquidus | liquidus |
|---|---|---|---|---|---|---|---|---|---|---|
| | | | Stain | Annealing | Softening | Young's | Shear | | temperature | viscosity |
| | Density | CTE | Point | Point | Point | modulus | modulus | Poisson's | Internal | Internal |
| | g/cc | 10⁻⁷/K | ° C. | ° C. | ° C. | GPa | ° C. | ratio | ° C. | kPa |
| 1 | 2.43 | 65 | 605 | 656 | 898.0 | 74.5 | 31.0 | 0.201 | 1170 | 51 |
| 2 | 2.43 | 66.6 | 601 | 651 | 888.6 | 74.3 | 30.9 | 0.203 | 1150 | 60 |
| 3 | 2.44 | 68.4 | 597 | 647 | 882.4 | 74.1 | 30.8 | 0.204 | 1135 | 73 |
| 4 | 2.43 | 63.6 | 608 | 659 | 902.0 | 74.8 | 31.1 | 0.203 | 1175 | 46 |
| 5 | 2.43 | 64.8 | 606 | 657 | 897.4 | 74.6 | 31.0 | 0.202 | 1155 | 63 |
| 6 | 2.44 | 67.8 | 598 | 648 | 885.7 | 74.9 | 31.1 | 0.205 | 1160 | 47 |
| 7 | 2.44 | 75.4 | 591 | 642 | 883.1 | 73.6 | 30.5 | 0.205 | 1100 | 164 |
| 8 | 2.44 | 75.9 | 590 | 640 | 884.1 | 73.7 | 30.5 | 0.207 | 1090 | 174 |
| 9 | 2.44 | 76.6 | 589 | 639 | 878.9 | 73.2 | 30.4 | 0.204 | 1090 | 149 |
| 10 | 2.44 | 76.3 | 586 | 637 | 879.5 | 73.1 | 30.3 | 0.205 | 1080 | 192 |
| 11 | 2.44 | 76.4 | 586 | 637 | 877.8 | 73.1 | 30.3 | 0.206 | 1070 | 185 |
| 12 | 2.44 | 76.6 | 587 | 637 | 878.8 | 73.1 | 30.3 | 0.206 | 1080 | 198 |
| 13 | 2.45 | 79.0 | 590 | 641 | 881.6 | 73.7 | 30.5 | 0.210 | 1080 | 172 |
| 14 | 2.45 | 79.5 | 589 | 639 | 879.5 | 73.5 | 30.4 | 0.208 | 1080 | 196 |
| 15 | 2.45 | 79.5 | 588 | 639 | 882.7 | 73.1 | 30.3 | 0.207 | 1070 | 232 |
| 16 | 2.44 | 80.3 | 587 | 639 | 883.6 | 72.9 | 30.1 | 0.209 | 1040 | 459 |
| 17 | 2.44 | 80.1 | 584 | 635 | 879.3 | 72.8 | 30.1 | 0.207 | 1040 | 427 |
| 18 | 2.45 | — | — | — | — | 72.9 | 30.2 | 0.208 | 1040 | 402 |
| 19 | 2.44 | 76.9 | 606 | 658 | 902.7 | 73.2 | 30.3 | 0.208 | 1080 | 278 |
| 20 | 2.44 | 79.8 | 594 | 646 | 895.0 | 72.2 | 29.9 | 0.208 | 995 | 2064 |
| 21 | 2.45 | 76.6 | 600 | 651 | 890.7 | 73.6 | 30.5 | 0.209 | 1090 | 175 |
| 22 | 2.44 | 78.8 | 591 | 643 | 885.7 | 72.5 | 30.1 | 0.206 | 1030 | 611 |
| 23 | 2.44 | 76.1 | 595 | 647 | 890.9 | 72.7 | 30.1 | 0.207 | 1045 | 421 |
| 24 | 2.44 | 76.3 | 592 | 643 | 887.0 | 73.0 | 30.3 | 0.207 | 1085 | 183 |
| 25 | 2.40 | 66.2 | 579 | 632 | 886.6 | 72.1 | 30.1 | 0.197 | 1065 | 477 |
| 26 | 2.41 | 67.9 | 584 | 636 | 884.7 | 72.2 | 30.2 | 0.196 | 1075 | 331 |
| 27 | 2.43 | 69.9 | 597 | 649 | 894.4 | 73.0 | 30.4 | 0.201 | 1085 | 242 |
| 28 | 2.44 | 72.7 | 606 | 657 | 902.9 | 73.4 | 30.5 | 0.204 | 1090 | 225 |
| 29 | 2.44 | 69.9 | 615 | 666 | 910.6 | 73.8 | 30.8 | 0.198 | 1135 | 110 |
| 30 | 2.45 | 75.4 | 618 | 669 | 912.2 | 73.8 | 30.8 | 0.201 | 1090 | 270 |
| 31 | 2.45 | 77.1 | 605 | 657 | 906.6 | 74.1 | 30.7 | 0.207 | 1085 | 300 |
| 32 | 2.45 | 78.5 | 608 | 660 | 907.3 | 74.2 | 30.8 | 0.207 | 1085 | 228 |
| 33 | 2.45 | 77.1 | 606 | 658 | 907.5 | 74.2 | 30.8 | 0.206 | 1095 | 144 |
| 34 | 2.45 | 84.8 | 581 | 633 | 885.7 | 73.2 | 30.3 | 0.209 | 1080 | 210 |
| 35 | 2.45 | 77.9 | 604 | 657 | 911.6 | 74.2 | 30.8 | 0.204 | 1105 | 242 |
| 36 | 2.45 | 77.9 | 607 | 659 | 905.3 | 74.1 | 30.7 | 0.209 | 1100 | 217 |
| 37 | 2.45 | 78.6 | 606 | 657 | 904.8 | 74.1 | 30.7 | 0.208 | 1085 | 297 |
| 38 | 2.44 | 77.7 | 605 | 657 | 906.8 | 74.1 | 30.8 | 0.205 | 1090 | 293 |
| 39 | 2.45 | 79.1 | 607 | 659 | 907.7 | 73.9 | 30.6 | 0.208 | <1135 | 127-200 |
| 40 | 2.44 | 77.8 | 597 | 651 | 910.2 | 73.8 | 30.6 | 0.206 | 1095 | 297 |
| 41 | 2.45 | 78.4 | 603 | 656 | 913.7 | 74.1 | 30.7 | 0.207 | 1110 | 216 |

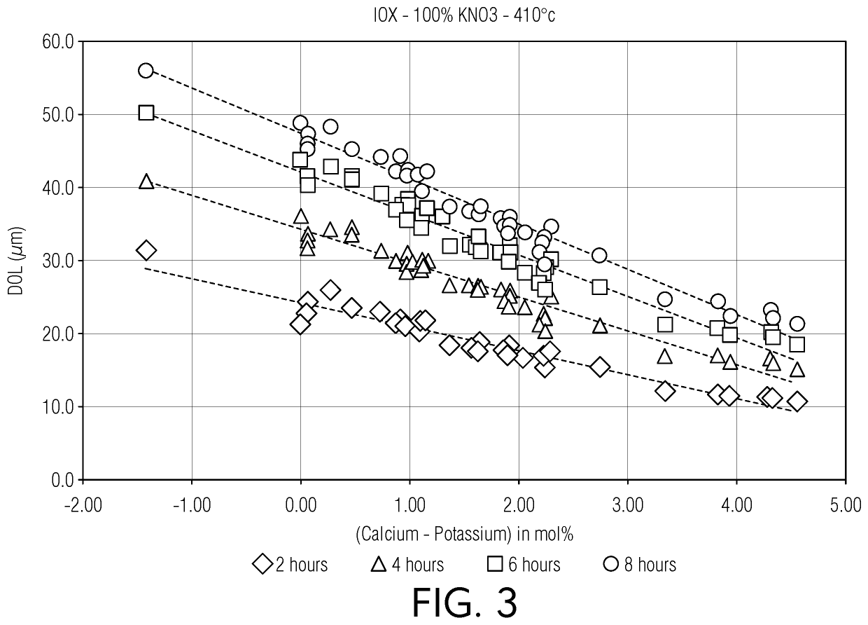

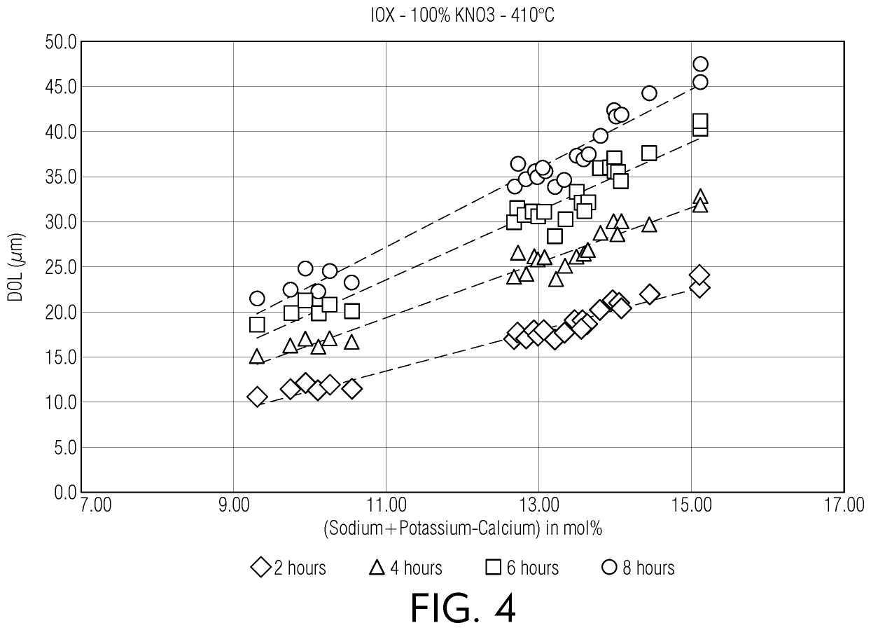

Table 1 and Table 2 list the compositions and physical properties of the Samples 1-41. Although Fe₂O₃ was detected in the glass composition, no iron was intentionally added to the glass melt, and Fe₂O₃ shows up in tramp amounts from background contamination. FIG. 3 and FIG. 4 provides the depth of layer (DOL) values for glasses after less than or equal to 8 hours of ion exchanging treatment and fictivated at 1011 Poise. FIG. 3 shows DOL achieved for glasses as a function of a glass composition parameter (CaO—K₂O) in mol %. FIG. 4 shows the DOL as a function of glass composition parameter (Na₂O+K₂O—CaO) in mol %. It was observed that the DOL was proportional to these two parameters in the glass composition system. The amount of CaO—K₂O content has a negative effect on the DOL while the amount of (Na₂O+K₂O—CaO) content has a positive effect.

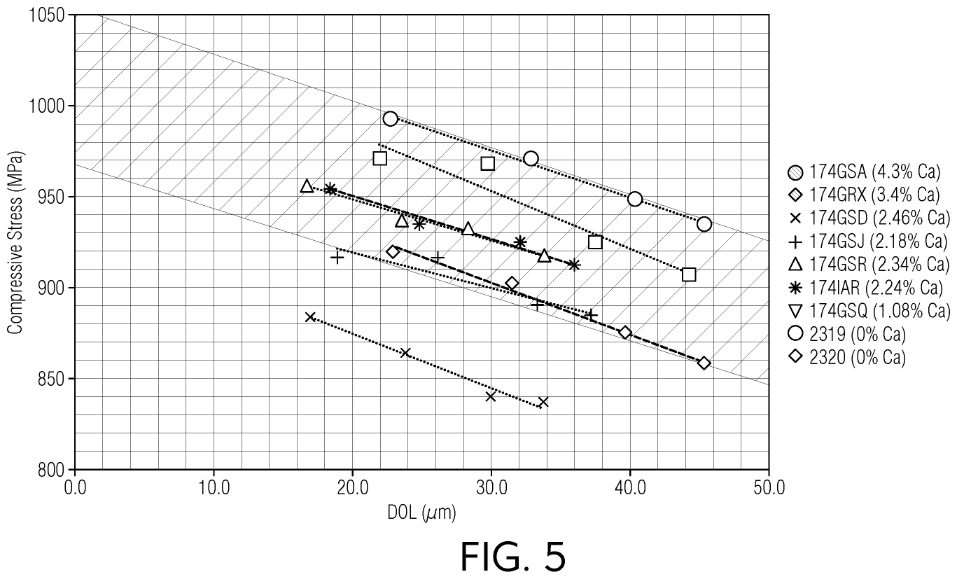

FIG. 5 is a plot graph of DOL versus CS of exemplary glass compositions in comparison with two calcium free commercial alkali aluminosilicate glasses. FIG. 5 exhibits that the CS and DOL values of glasses samples in the current disclosed compositions are comparable to the commercial alkali aluminosilicate glasses, suggesting the SLG cullet as raw materials are acceptable for high performance alkali aluminosilicate glasses.

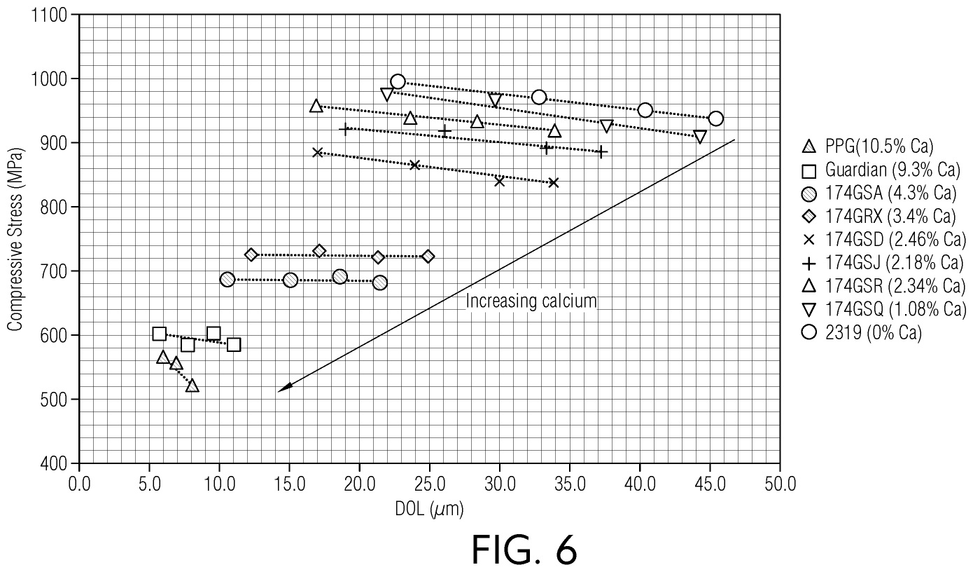

FIG. 6 is a plot graph of DOL versus CS of exemplary glass compositions of various calcium content in comparison with PPG SLG and Guardian SLG. FIG. 6 provides that glasses with higher calcium content exhibits lower DOL and CS. Further, the current disclosed compositions, with SLG as raw materials, exhibit high ion-exchange properties and strengthen.

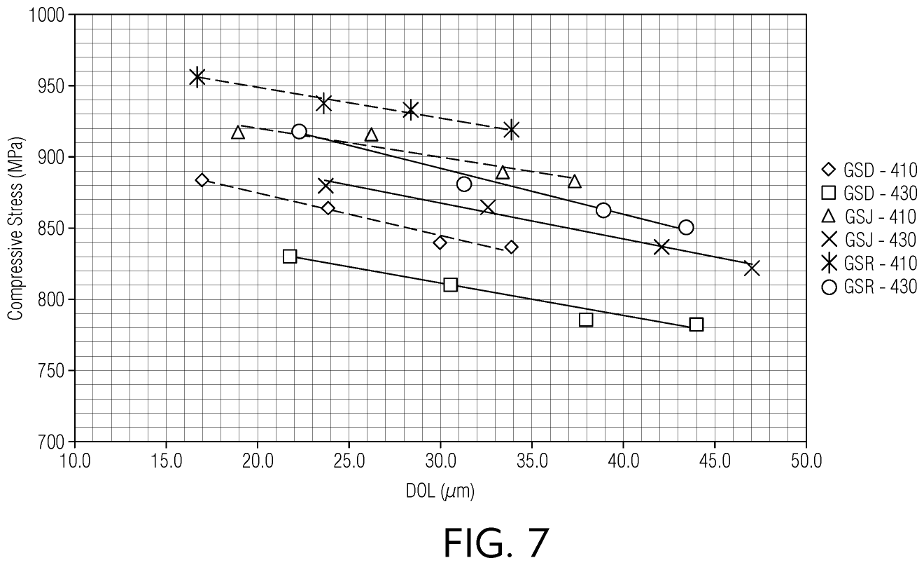

FIG. 7 is a plot graph of DOL versus CS of exemplary glass compositions with different ion exchange treated time and temperature. The disclosed compositions exhibit high temperature stability and treatment time stability: the glasses lose about 30-40 MPa per 20 degree increase in ion exchange temperature, and lose about 5-10 MPa per hour increase in ion exchange treatment time.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An alkali aluminosilicate glass article comprising:
from greater than or equal to 68.5 mol % to less than or equal to 76.5 mol % SiO₂;
from greater than or equal to 5.5 mol % to less than or equal to 11.0 mol % Al₂O₃;
from greater than or equal to 9.0 mol % to less than or equal to 14.5 mol % Na₂O;
from greater than or equal to 4.0 mol % to less than or equal to 5.7 mol % MgO;
from greater than or equal to 1.0 mol % to less than or equal to 4.8 mol % CaO;
from greater than or equal to 0.05 mol % to less than or equal to 3.9 mol % K₂O; and
wherein CaO mol %−K₂O mol % is greater than or equal to −1.5 mol % and less than or equal to 4.8 mol %.

2. The glass article of claim 1, wherein the glass article comprises:
from greater than or equal to 68.7 mol % to less than or equal to 73.0 mol % SiO₂;
from greater than or equal to 7.7 mol % to less than or equal to 10.8 mol % Al₂O₃;
from greater than or equal to 10.7 mol % to less than or equal to 13.7 mol % Na₂O;
from greater than or equal to 4.4 mol % to less than or equal to 5.5 mol % MgO;
from greater than or equal to 1.6 mol % to less than or equal to 3.5 mol % CaO;
from greater than or equal to 0.1 mol % to less than or equal to 2.1 mol % K₂O; and
wherein CaO mol %−K₂O mol % is greater than or equal to 0.2 mol % and less than or equal to 3.4 mol %.

3. The glass article of claim 1, wherein the glass article comprises:
from greater than or equal to 69.0 mol % to less than or equal to 69.2 mol % SiO₂;
from greater than or equal to 10.0 mol % to less than or equal to 10.7 mol % Al₂O₃;
from greater than or equal to 12.5 mol % to less than or equal to 13.0 mol % Na₂O;
from greater than or equal to 4.8 mol % to less than or equal to 5.2 mol % MgO;
from greater than or equal to 2.2 mol % to less than or equal to 2.3 mol % CaO;
from greater than or equal to 0.2 mol % to less than or equal to 0.4 mol % K₂O; and
wherein CaO mol %−K₂O mol % is greater than or equal to 1.9 mol % and less than or equal to 2.1 mol %.

4. The glass article of claim 1, wherein a molar ratio of MgO to RO is greater than or equal to 0.5 and less than or equal to 0.8, wherein RO is the sum of alkaline earth metals in the glass article.

5. The glass article of claim 1, wherein the sum of RO and R₂O is greater than or equal to 17.5 mol % and less than or equal to 21.0 mol %, wherein RO is the sum of alkaline earth metals in the glass article and R₂O is the sum of alkali metals in the glass article.

6. The glass article of claim 1, wherein RO mol %+Al₂O₃ mol % is greater than or equal to 13.0 mol % and less than or equal to 18.0 mol %.

7. The glass article of claim 1, wherein (RO mol %+R₂O mol %)−Al₂O₃ mol % is greater than or equal to 9.0 mol % and less than or equal to 13.0 mol %.

8. The glass article of claim 1, wherein (RO mol %+R₂O mol %)/Al₂O₃ mol % is greater than or equal to 1.85 and less than or equal to 3.50.

9. The glass article of claim 1, wherein R₂O mol %−CaO mol % is greater than or equal to 9.0 mol % and less than or equal to 15.0 mol %.

10. The glass article of claim 1, wherein the glass article comprises a liquidus viscosity in a range of 45 kPa to 2065 kPa.

11. The glass article of claim 1, wherein the glass article comprises a Young's modulus value in a range of 72.0 MPa to 75.0 MPa.

12. The glass article of claim 1, wherein the glass article is substantially free of B₂O₃, P₂O₅, and Li₂O.

13. The glass article of claim 1, wherein the glass article comprises less than or equal to 0.2 mol % SnO₂.

14. An ion-exchange strengthened alkali aluminosilicate glass article comprising:
from greater than or equal to 68.5 mol % to less than or equal to 76.5 mol % SiO₂;
from greater than or equal to 5.5 mol % to less than or equal to 11.0 mol % Al₂O₃;
from greater than or equal to 9.0 mol % to less than or equal to 14.5 mol % Na₂O;
from greater than or equal to 4.0 mol % to less than or equal to 5.7 mol % MgO;
from greater than or equal to 1.0 mol % to less than or equal to 4.8 mol % CaO;
from greater than or equal to 0.05 mol % to less than or equal to 3.9 mol % K₂O;
wherein CaO mol %−K₂O mol % is greater than or equal to −1.5 mol % and less than or equal to 4.8 mol %; and
wherein the ion-exchange strengthened glass article has one or more compressed surface layers.

15. The ion-exchange strengthened alkali aluminosilicate glass article of claim 14, wherein the glass article comprises:
from greater than or equal to 68.7 mol % to less than or equal to 73.0 mol % SiO₂;
from greater than or equal to 7.7 mol % to less than or equal to 10.8 mol % Al₂O₃;
from greater than or equal to 10.7 mol % to less than or equal to 13.7 mol % Na₂O;
from greater than or equal to 4.4 mol % to less than or equal to 5.5 mol % MgO;
from greater than or equal to 1.6 mol % to less than or equal to 3.5 mol % CaO;
from greater than or equal to 0.1 mol % to less than or equal to 2.1 mol % K₂O; and
wherein CaO mol %−K₂O mol % is greater than or equal to 0.2 mol % and less than or equal to 3.4 mol %.

16. The ion-exchange strengthened alkali aluminosilicate glass article of claim 14, wherein the glass article comprises:
from greater than or equal to 69.0 mol % to less than or equal to 69.2 mol % SiO₂;
from greater than or equal to 10.0 mol % to less than or equal to 10.7 mol % Al₂O₃;
from greater than or equal to 12.5 mol % to less than or equal to 13.0 mol % Na₂O;
from greater than or equal to 4.8 mol % to less than or equal to 5.2 mol % MgO;
from greater than or equal to 2.2 mol % to less than or equal to 2.3 mol % CaO;
from greater than or equal to 0.2 mol % to less than or equal to 0.4 mol % K₂O; and
wherein CaO mol %−K₂O mol % is greater than or equal to 1.9 mol % and less than or equal to 2.1 mol %.

17. The ion-exchange strengthened alkali aluminosilicate glass article of claim 14, wherein the glass article is made from raw materials comprising at least soda-lime glass cullet.

18. The ion-exchange strengthened alkali aluminosilicate glass article of claim 14, wherein the glass article comprises a compressive stress in a range of 400 MPa to 1000 MPa.

19. The ion-exchange strengthened alkali aluminosilicate glass article of claim 14, wherein the glass article comprises a depth of length in a range of 4.0 μm to 56.5 μm.

20. An electronic device comprises a housing, a display, a cover substrate adjacent to the display, wherein the cover substrate comprises the glass article of claim 14.
